(19) United States
(12) Patent Application Publication
(10) Pub. No.: US 2025/0155277 A1
(43) Pub. Date: May 15, 2025

(54) SIGNAL PROCESSING METHOD AND SIGNAL PROCESSING EQUIPMENT

(71) Applicant: NIPPON TELEGRAPH AND TELEPHONE CORPORATION, Tokyo (JP)

(72) Inventors: Yoshifumi WAKISAKA, Musashino-shi, Tokyo (JP); Hiroshi TAKAHASHI, Musashino-shi, Tokyo (JP); Daisuke IIDA, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/725,072

(22) PCT Filed: Jan. 11, 2022
(86) PCT No.: PCT/JP2022/000476

§ 371 Date: Jun. 27, 2024

(51) Int. Cl. G01H 9/00

(52) U.S. Cl. CPC G01H 9/004

(57) ABSTRACT

In order to achieve the above object, a signal processing method according to the present disclosure includes: a calculation step of calculating a phase change at each of points on a medium from a phase of a reflected signal generated by a pulse signal transmitted to the medium, at each of predetermined times; a phase connection step of performing phase connection processing, at each of the predetermined times, on the phase change at each of the points calculated in the calculation step; and a correction step of detecting an outlier using a phase change at each of the points at the same time at which the phase connection processing is performed in the phase connection step, and correcting the outlier, at each of the predetermined times.

### TECHNICAL FIELD

The present invention relates to a signal processing method and a signal processing device for correcting a phase connection error.

### BACKGROUND ART

Physical vibration applied to an optical fiber appears as a temporal change in strain of the optical fiber. Using this, as a means for measuring physical vibration (a temporal change in the strain) applied to an optical fiber in a distributed manner in a longitudinal direction of the optical fiber, there has been known distributed acoustic sensing (DAS) in which pulsed test light is injected into a measurement target optical fiber and backscattered light originating from Rayleigh scattering is detected (refer to, for example, Non Patent Literature 1).

As one of the methods of detecting backscattered light in DAS, DAS-phase (DAS-P) has been known as a method of measuring the phase of backscattered light from each point on the measurement target optical fiber, and observing temporal changes in phase. In DAS-P, the vibration can be quantitatively measured, and the vibration waveform applied to the measurement target optical fiber can be faithfully reproduced (refer to, for example, Non Patent Literature 2).

Specifically, in measurement by DAS-P, an optical pulse signal is injected into the measurement target optical fiber, and a phase of scattered light at a time t at which the optical pulse signal enters is measured in a distributed manner in a longitudinal direction of the optical fiber. That is, a phase θ(l, t) of the backscattered light is measured, with a distance from an injection end of the optical fiber being a distance l. The optical pulse signal is repeatedly injected into the measurement target optical fiber at a time interval T, and thus a temporal change θ(l, nT) in phase of the scattered light at the time t=nT, n being an integer, is measured for each point in the longitudinal direction of the measurement target optical fiber.

In actual measurement, however, there is a time-lag, between the time for measuring the point at the distance l and the time at which the optical pulse signal is injected, corresponding to the time during which the optical pulse signal propagates from the injection end over the distance l. Further, there is a time-lag, before the backscattered light is measured by a measuring instrument corresponding to the time required for the backscattered light to return to the injection end. Since the speed of light in the optical fiber is much faster than the speed of sound, these time-lags can be disregarded except for what needs to be taken into account in particular. In the present invention, these time-lags are not taken into account in the following description since they do not need to be taken into account in particular.

The magnitude of physical vibration applied in the section from the distance l to a distance l+δl at each time nT has a linear relationship with a difference δθ(l, nT) between a phase θ(l+δl, nT) at the distance l+δl and a phase θ(l, nT) at the distance l. Given that a strain amount at time zero is a reference point (zero point) of the temporal change in the strain, Expression (1) is satisfied.

$$\begin{matrix}[ Math . 1 ] & \\ ( Magnitude of vibration ) ∝ δθ ( l , nT ) - δθ ( l , 0 ) = [ θ ( l + δl , nT ) - θ ( l , nT ) ] - [ θ ( l + δl , 0 ) - θ ( l , 0 ) ] = [ θ ( l + δl , nT ) - θ ( l + δ l , 0 ) ] - [ θ ( l , nT ) - θ ( l , 0 ) ] & ( 1 )\end{matrix}$$

As device configurations for detecting the phase of backscattered light, there are a direct detection configuration that directly detects backscattered light from the measurement target optical fiber with a photodiode or the like, and a configuration that uses coherent detection to detect backscattered light multiplexed with separately prepared reference light (refer to, for example, Non Patent Literature 1).

Mechanisms for performing coherent detection and calculating a phase are specifically classified into two kinds, which are mechanisms for software-based processing using Hilbert transform, and mechanisms for hardware-based processing using a 90-degree optical hybrid. In both kinds of methods, an in-phase component I(l, nT) and a quadrature component Q(l, nT) of backscattered light are acquired, and a phase θ_{cal}(l, nT) is calculated in accordance with Expression (2).

$$\begin{matrix}[ Math . 2 ] & \\ {θ}_{cal} ( l , nT ) = Arctan [ \frac{Q ( l , nT )}{I ( l , nT )} ] & ( 2 )\end{matrix}$$

In actual measurement, there are plural kinds of device configurations and plural kinds of phase calculation for detecting the phase of backscattered light. The phase value of the backscattered light detected before phase connection processing or the like is distinguished from θ(l, nT) and set as θ_{cal}(l, nT). In this regard, θ_{cal}(l, nT) is expressed by the four-quadrant arctangent operator Arctan as shown in Expression (2), and is wrapped within the range of (−π, π] in radians, 2mπ+θ_{cal}(l, nT) all have the same vector direction in an x-y plane (m can be any integer.), and accordingly, the uncertainty of 2mπ exists in θ_{cal}(l, nT). Therefore, the influence of the uncertainty also appears in the difference δθ_{cal}(l, nT) calculated from the phase θ_{cal}(l+δl, nT) at the distance l+δl and the phase θ_{cal}(l, nT) at the distance l.

Therefore, as a more accurate evaluation method for δθ(l, nT), phase connection processing such as phase unwrapping processing is further performed. An actual phase change that is a measurement target is δθ(l, nT), and a measured value of a phase change obtained through calculation from a measurement result is δθ_{cal}(l, nT); both phase changes are distinguished from each other.

In general phase unwrapping processing, a phase after phase unwrapping processing is set as δθ_{cal}^{unwrap}(l, nT), δθ_{cal}^{unwrap}(l, 0)=δθ_{cal}(l, 0) is defined, and then successive calculations are performed as follows in ascending order of n. Regarding on integer p that can be any integer, when |θ_{cal}(l, (p+1)T)−δθ_{cal}^{unwrap}(l, pT)| is larger than π radians, an appropriate integer q is selected such that |δθ_{cal}(l, (p+1)T)+2πq−δθ_{cal}^{unwrap}(l, pT)| is π radians or less, and a phase δθ_{cal}^{unwrap}(l, (p+1)T) after phase unwrapping processing is calculated as in Expression (3). The superscript “unwrap” indicates that the phase is a phase after phase unwrapping processing.

$$\begin{matrix}[ Math . 3 ] & \\ {δθ}_{cal}^{unwrap} ( l , ( p + 1 ) T ) = {δθ}_{cal} ( l , ( p + 1 ) T ) + 2 π q & ( 3 )\end{matrix}$$

In the phase δθ_{cal}^{unwrap}(l, nT) after phase unwrapping processing obtained from Expression (3), δθ(l, nT) can be accurately obtained only when an absolute value of the phase change between adjacent times of δθ is smaller than π radians at a time and a location and, ideally, δθ_{cal}(l, nT) is not accompanied by noise.

In actual measurement, a failure of the phase unwrapping processing is caused by noise accompanying δθ_{cal}(l, nT) as well. In actual measurement, there is noise from the measuring instrument, such as thermal noise from a PD for detecting light, noise at the subsequent electrical stage, and shot noise caused by light. Therefore, noise accompanies the in-phase component I(l, nT) and the quadrature component Q(l, nT) in Expression (2), noise is also added to θ_{cal}(l, nT), and as a result, noise accompanies δθ_{cal}(l, nT). The noise generated in δθ_{cal}(l, nT) results in the possibility of erroneously selecting an appropriate integer q.

Regarding this problem, it is possible to take a measure to reduce the probability of erroneous selection of the integer q by reducing the noise generated in δθ_{cal}(l, nT) as much as possible using a method such as frequency multiplexing or the like. However, even when such a measure is implemented, the probability of erroneous selection of the integer q due to noise cannot be made zero in principle. Therefore, in the data measured over a long period of time, a failure of the phase unwrapping processing arises. When a failure of the phase unwrapping processing arises, it leads to erroneous detection of applying apparent large vibration at a point where the failure arises.

### CITATION LIST

### Non Patent Literature

Non Patent Literature 1: A. Masoudi, T. P. Newson, “Contributed Review: Distributed optical fibre dynamic strain sensing”, Review of Scientific Instruments, vol. 87, p. 011501 (2016)
Non Patent Literature 2: Ken'ichi Nishiguchi, Che-Hsien Li, Artur Guzik, Mitsunori Yokoyama, Kinzo Kishida, “Fabrication of Fiber-Optic Distributed Acoustic Sensor and Its Signal Processing”, IEICE Technical Report, 115 (202), pp. 29-34 (2015)

### SUMMARY OF INVENTION

### Technical Problem

As a method of further reducing such erroneous detection of applying apparent large vibration due to the phase connection error, it is also conceivable to further perform signal processing for detecting and correcting the phase connection error in δθ_{cal}(l, nT) subjected to the phase connection processing. This related art, as a feature of the signal processing, includes a first correction step of performing outlier correction of a phase value in dimension of a fiber's longitudinal space (l) for each position in the space in a predetermined direction at a predetermined time (specific n) in δθ_{cal}(l, nT) subjected to the phase connection processing, and a second correction step of correcting a phase value at a time other than the predetermined time, for each of correction target positions in the first correction step of positions in the space are included. By repeating the first correction step and the second correction step with the time changed, all 1 and nT of δθ_{cal}(l, nT) are corrected, and erroneous detection of apparent large vibration due to a failure of the phase unwrapping processing is reduced. As a specific means for correcting the outlier, a method using a Hampel identifier in which a parameter is set in proportion to the resolution or the like determined from an OTDR's pulse width is considered.

In the signal processing method for detecting and correcting a phase connection error in δθ_{cal}(l, nT) subjected to the phase connection processing in order to reduce erroneous detection of applying apparent large vibration accompanying the phase connection error, first, the phase connection processing is performed on the whole θ_{cal}(l, nT), and then a process of detecting a phase connection error portion as a phase outlier and correcting the outlier is performed on the whole δθ_{cal}(l, nT) subjected to the phase connection processing. Therefore, the processing is batch processing in which the phase connection processing cannot be performed until termination of the acquisition of all data of δθ_{cal}(l, nT), and there is a first problem that the processing cannot be used to process measurement data in real-time at the same time that the measurement data is streamed. In addition, in the signal processing method, in the second correction step, it is necessary to correct the phase values at all different times at the correction target point, and there is a second problem that the calculation amount increases.

In order to solve the above problems, an object of the present disclosure is to lessen a calculation amount and to thereby process measurement data in real-time at the same time that the measurement data is streamed.

### Solution to Problem

In order to achieve the above object, in the present disclosure, phase connection processing and phase connection error correction are performed on a phase change of a reflected signal generated by an entering pulse signal at each predetermined time.

Specifically, a signal processing method according to the present disclosure includes:
A calculation step of calculating a phase change at each of points on a medium from a phase of a reflected signal generated by a pulse signal transmitted to the medium, at each of predetermined times;
a phase connection step of performing phase connection processing, at each of the predetermined times, on the phase change at each of the points calculated in the calculation step; and
a correction step of detecting an outlier using a phase change at each of the points at the same time at which the phase connection processing is performed in the phase connection step, and correcting the outlier, at each of the predetermined times.

In the signal processing method according to the present disclosure, in the phase connection step, for each of the points, a phase to be added to a phase change after the latest calculation step may be determined depending on a magnitude of a difference between the phase change after the latest calculation step and a phase change after the correction step at a previous time.

In the signal processing method according to the present disclosure, in the correction step, correction using a Hampel identifier may be performed.

The signal processing method according to the present disclosure may further comprise, before the calculation step, a reference calculation step of calculating, for each of the points, a phase difference between two points, which are the point and a point a predetermined distance away from the point, as a reference phase difference, and
in the calculation step, the phase difference between the two points may be calculated for each of the points, and the phase change may be calculated by subtracting the reference phase difference from the calculated phase difference.

In the signal processing method according to the present disclosure, the medium may be an optical fiber, the pulse signal may be an optical pulse signal, and the reflected signal may be backscattered light originating from Rayleigh scattering in the optical fiber.

Specifically, a signal processing device according to the present disclosure includes:
a calculation unit that calculates a phase change at each of points on a medium from a phase of a reflected signal generated by a pulse signal transmitted to the medium, at each of predetermined times;
a phase connection unit that performs phase connection processing, at each of the predetermined times, on the phase change at each of the points calculated by the calculation unit; and
a correction unit that detects an outlier using a phase change at each of the points at the same time at which the phase connection unit performs the phase connection processing, and corrects the outlier, at each of the predetermined times.

Specifically, a program according to the present disclosure is implemented on a computer as the signal processing device.

Note that the inventions described above can be combined in any possible manner.

### Advantageous Effects of Invention

According to the present disclosure, it is practical to lessen a calculation amount and to thereby process measurement data in real-time at the same time that the measurement data is streamed.

### BRIEF DESCRIPTION OF DRAWINGS

FIG. 1 schematically illustrates an example of a signal processing system according to a first embodiment.

FIG. 2 illustrates an example of a procedure of a signal processing method according to the first embodiment.

FIG. 3 is a view illustrating a program according to the present disclosure.

### DESCRIPTION OF EMBODIMENTS

Hereinafter, embodiments of the present disclosure will be described in detail with reference to the drawings. The present disclosure is not limited to the embodiments to be described below. These embodiments are merely examples, and the present disclosure can be implemented in a form with various modifications and improvements based on the knowledge of those skilled in the art. Components having the same reference numerals in the present specification and the drawings are the same components.

### First Embodiment

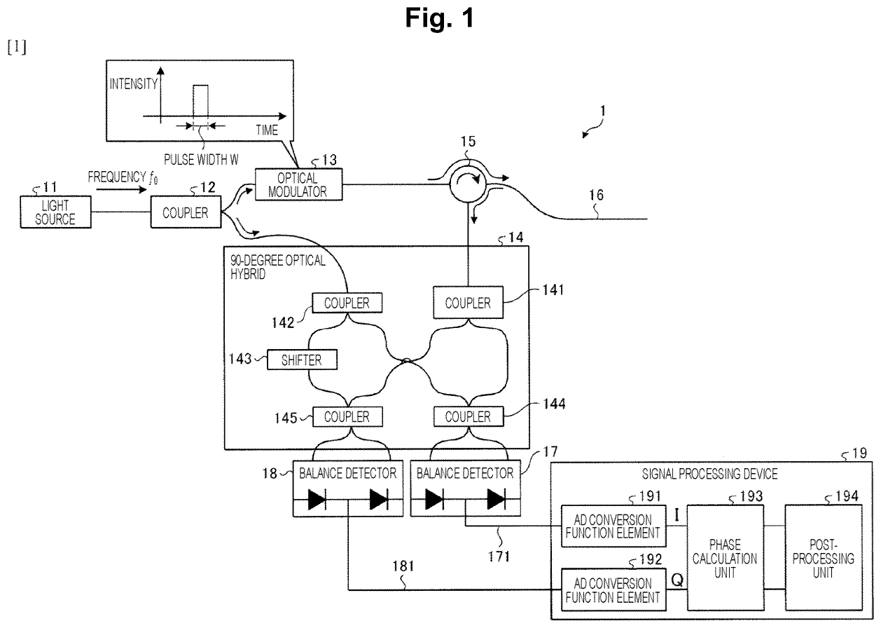

FIG. 1 is a diagram illustrating a configuration example of a signal processing system according to the present embodiment. A signal processing system 1 in FIG. 1 performs DAS-P through coherent detection using a hardware-based processing mechanism where a 90-degree optical hybrid is employed in a reception system. The signal processing system 1 functions as a phase optical time domain reflectometer (OTDR).

A signal processing method in the present embodiment reduces erroneous detection of apparent large vibration caused by a failure of phase unwrapping processing, and is different from DAS-P according to the related art. In addition, in a signal processing method equivalent to the method in the first embodiment, the phase calculation may be performed on a software basis by using Hilbert transform without employing a 90-degree optical hybrid in a reception system. In addition, in the present invention, regardless of the specific configuration of DAS-P, results of phase measurement by DAS-P can be used.

As illustrated in FIG. 1, a light source 11, a coupler 12, an optical modulator 13, a 90-degree optical hybrid 14, a circulator 15, a measurement target optical fiber 16, a balance detector 17, a balance detector 18, and a signal processing device 19 are included. In addition, the light source 11, the coupler 12, the optical modulator 13, the 90-degree optical hybrid 14, the circulator 15, the measurement target optical fiber 16, the balance detector 17, and the balance detector 18 function as measuring instruments.

The light source 11 emits continuous light having a single wavelength of which a frequency is f₀. For example, the light source 11 is a continuous wave (CW) light source. The coupler 12 branches the continuous light emitted by the light source 11 into reference light and probe light.

The optical modulator 13 generates an optical pulse signal having a pulse width W from the probe light branched by the coupler 12. The pulse width W is a value corresponding to a spatial resolution in measurement in a longitudinal direction of the optical fiber. The optical frequency of the optical pulse signal is set to a value obtained by shifting the frequency f₀ by a shift frequency.

The optical pulse signal generated by the optical modulator 13 may not be a single-frequency optical pulse signal as long as the method is capable of finally measuring a phase change, and frequency sweeping, frequency multiplexing, and other encoding can be performed.

The optical modulator 13 may have any type as long as the optical pulse signal as described above is generated, and may be replaced with a plurality of optical modulators each of which is equivalent thereto. For example, the optical modulator 13 may be a single side-band (SSB) modulator, a frequency-variable acousto-optics (AO) modulator, or the like. The optical modulator 13 may perform intensity modulation by using a semiconductor optical amplifier (SOA) or the like in order to increase an extinction ratio in pulsing.

The optical pulse signal generated by the optical modulator 13 is injected thereto the measurement target optical fiber 16, via the circulator 15, as probe light.

Here, the light scattered at each point in the longitudinal direction of the measurement target optical fiber 16 returns to the circulator 15 as backscattered light and enters one input of the 90-degree optical hybrid 14. The reference light branched by the coupler 12 enters the other input of the 90-degree optical hybrid 14.

As illustrated in FIG. 1, the 90-degree optical hybrid 14 includes a coupler 141, a coupler 142, a shifter 143, a coupler 144, and a coupler 145.

First, the backscattered light from the measurement target optical fiber 16 enters an input of the coupler 141 having a branching ratio of 50:50. The backscattered light branched by the coupler 141 enters an input of the coupler 145 having a branching ratio of 50:50 and an input of the coupler 144 having a branching ratio of 50:50.

The reference light from the coupler 12 enters an input of the coupler 142 having a branching ratio of 50:50. One of reference light beams branched by the coupler 142 directly enters the input of the coupler 144.

The shifter 143 shifts a phase of the other reference light beam branched by the coupler 142, by π/2. The reference light of which the phase has been shifted by the shifter 143 enters the input of the coupler 145.

Here, the balance detector 17 detects two outputs from the coupler 144 and acquires an electrical signal 171 of which an analog in-phase component is I^{analog}.

The balance detector 18 detects two outputs from the coupler 145 and acquires an electrical signal 181 of which an analog quadrature component is Q^{analog}.

The electrical signal 171 and the electrical signal 181 are sent to the signal processing device 19. As illustrated in FIG. 1, the signal processing device 19 includes an AD conversion function element 191, an AD conversion function element 192, a phase calculation unit 193, and a post-processing unit 194.

The signal processing device 19 includes a calculation unit that calculates a phase change at each of points on a medium from a phase of a reflected signal generated by a pulse signal transmitted to the medium, at each of predetermined times, a phase connection unit that performs phase connection processing, at each of the predetermined times, on the phase change at each of the points calculated by the calculation unit, and a correction unit that detects an outlier using a phase change at each of the points at the same time at which the phase connection unit performs the phase connection processing, and corrects the outlier, at each of the predetermined times. The post-processing unit 194 in the signal processing device 19 may include the above-described calculation unit, phase connection unit, and correction unit.

The AD conversion function element 191 digitizes the analog in-phase component I^{analog} to obtain I^{digital}. The AD conversion function element 192 digitizes the analog quadrature component Q^{analog} to obtain Q^{digital}.

The phase calculation unit 193 performs phase calculation by using the digitized in-phase component I^{digital} output from the AD conversion function element 191 and the quadrature component Q^{digital} output from the AD conversion function element 192.

For example, when the optical pulse signal generated by the optical modulator 13 has a single frequency, the phase calculation unit 193 can calculate the phase in accordance with Expression (2) as the argument of the complex number in which the real part is I^{analog} and the imaginary part is Q^{digital}.

The phase calculation unit 193 may perform appropriate preprocessing. For example, the phase calculation unit 193 may calculate the phase as the argument of the complex number described above in accordance with Expression (2) after the signals having the in-phase component I^{digital} and the quadrature component Q^{digital} are filtered with a digital band pass filter having a signal bandwidth centered on the shift frequency at the time of modulation of the optical pulse signal to remove noise.

Even when frequency sweeping, frequency multiplexing, or other encoding is performed on the optical pulse signal, the phase calculation unit 193 can calculate the phase by performing appropriate preprocessing.

When the phase calculated by the phase calculation unit 193 remains unprocessed, there may be erroneous detection of apparent large vibration caused by a failure of phase unwrapping process. Therefore, the post-processing unit 194 performs processing for reducing such erroneous detection of apparent large vibration.

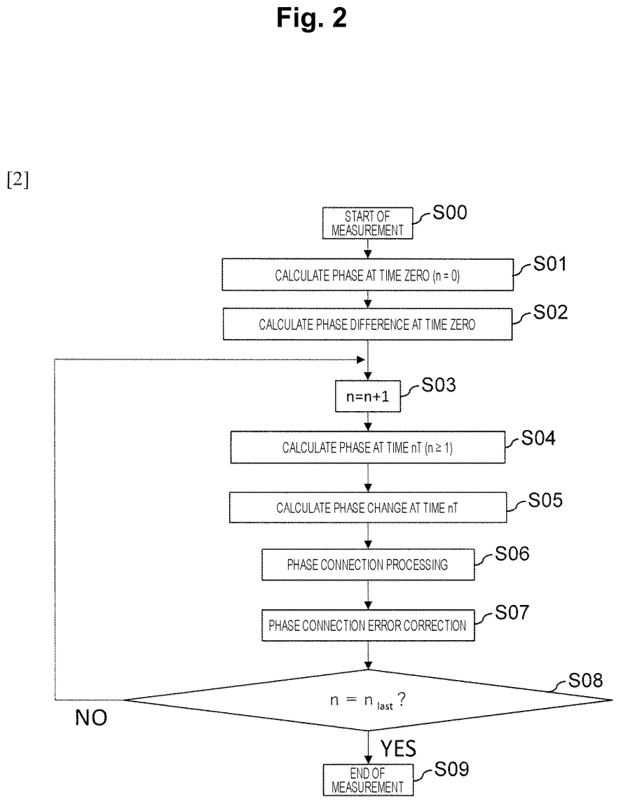

Here, a flow of processing performed by the post-processing unit 194 will be described with reference to FIG. 2. FIG. 2 illustrates an example of a procedure of the signal processing method according to the first embodiment.

The signal processing method according to the present embodiment includes a calculation step of calculating a phase change at each of points on a medium from a phase of a reflected signal generated by a pulse signal transmitted to the medium, at each of the predetermined times, a phase connection step of performing phase connection processing, at each of the predetermined times, on the phase change at each of the points calculated in the calculation step, and a correction step of detecting an outlier using the phase change at each of the points at the same time at which the phase connection processing is performed in the phase connection step, and correcting the outlier, at each of the predetermined times. Here, each of the predetermined times is a time nT in which n used here is each integer of 1 to nₗₐₛₜ. In addition, the phase unwrapping processing will be described below as an example of the phase connection processing, but the phase connection processing is not limited thereto. The signal processing method according to the present embodiment may be performed by the post-processing unit 194 in the signal processing device 19 described above.

In addition, in the signal processing method according to the present embodiment, the medium may be an optical fiber, the pulse signal may be an optical pulse signal, and the reflected signal may be backscattered light originating from Rayleigh scattering in the optical fiber, which will be described below as examples.

The medium, the pulse signal, and the reflected signal are not limited thereto. The medium may be a space, the pulse signal may be a pulse signal by laser, and the reflected signal may be a reflected signal from an object.

The calculation step corresponds to Step S05 of FIG. 2. The phase connection step corresponds to Step S06 of FIG. 2. The correction step corresponds to Step S07 of FIG. 2. Each step will be described below.

### (Step S00)

In the signal processing system 1 according to the present embodiment, an optical pulse signal obtained by modulating continuous light from the light source 11 is injected into the measurement target optical fiber 16, and measurement of backscattered light from the measurement target optical fiber 16 is started.

### (Step S01)

The phase calculation unit 193 calculates θ_{cal}(l, 0) from the backscattered light data of a component I and a component Q of the backscattered light of the optical pulse signal injected at reference time (hereinafter, the “reference time” is simply referred to as “time zero”). For example, the phase calculation unit 193 calculates θ_{cal}(l, 0) in accordance with Expression (2) described above.

### (Step S02)

The signal processing method according to the present embodiment may further include, before the calculation step, a reference calculation step of calculating, for each of points, a phase difference between two points, which are a point and a point a predetermined distance away from the point, as a reference phase difference.

Specifically, by using θ_{cal}(l, 0), the post-processing unit 194 calculates, for each of the points at a distance rΔl from the injection end on the measurement target optical fiber 16, a phase difference between two points having a width DΔl extending to the order of spatial resolution as a reference phase difference in accordance with Expression (4) at time zero (n=0).

$$\begin{matrix}[ Math . 4 ] & \\ {δθ}_{cal} ( r Δ l , 0 ) = {θ}_{cal} ( ( r + D ) Δ l , 0 ) - {θ}_{cal} ( r Δ l , 0 ) & ( 4 )\end{matrix}$$

Here, Δl is a spatial sampling interval in the longitudinal direction of the fiber, r is an integer for designating a position in the longitudinal direction of the fiber, and D is an integer selected for getting DΔl extending to the order of spatial resolution. In addition, a position where r equals zero corresponds to the injection end on the measurement target optical fiber 16. The value of δθ_{cal}(rΔl, 0) is held in the post-processing unit 194.

### (Step S03)

The post-processing unit 194 increments n by one. As described later, the post-processing unit 194 executes Steps S04 to S08 in regard to each n from 1 to nₗₐₛₜ.

### (Step S04)

The measuring instrument sequentially generates, for each of the points at the distance rΔl from the injection end on the measurement target optical fiber 16, the backscattered light data of the component I and the component Q of the backscattered light of the optical pulse signal injected at a time nT (n=1, 2, . . . , nₗₐₛₜ). The phase calculation unit 193 sequentially calculates θ_{cal}(rΔl, nT) at each time nT with regard to the generated backscattered light data at the time nT.

### (Step S05)

In the signal processing method according to the present embodiment, in the calculation step, the phase difference between two points is calculated for each of the points, and a phase change is calculated by subtracting the reference phase difference from the calculated phase difference.

Specifically, the post-processing unit 194 calculates, for each of the points at the distance rΔl from the injection end on the measurement target optical fiber 16, a phase change δθ_{cal}(rΔl, nT), based on the reference phase difference at time zero, added to the section having the width DΔl extending to the order of spatial resolution, in accordance with Expression (5).

$$\begin{matrix}[ Math . 5 ] & \\ {δθ}_{cal} ( r Δ l , nT ) = {θ}_{cal} ( ( r + D ) Δ l , nT ) - {θ}_{cal} ( r Δ l , nT ) - {δθ}_{cal} ( r Δ l , 0 ) & ( 5 )\end{matrix}$$

### (Step S06)

As the phase connection step, for each of the points, the phase to be added to the phase change after the latest calculation step is determined depending on the magnitude of the difference between the phase change after the latest calculation step and the phase change after the correction step at the previous time.

That is, phase unwrapping processing from δθ_{cal}^{unwrap}(rΔl, (n−1)T) at the time (n−1)T to δθ_{cal}(rΔl, nT) at the time nT is performed for each of the points at the distance rΔl from the injection end on the measurement target optical fiber.

In the phase unwrapping processing according to the present embodiment, as described above, an appropriate integer q is selected so that |δθ_{cal}(rΔl, nT)+2πq−δθ_{cal}^{unwrap}(rΔl, (n−1)T)| is π radians or less, and a phase δθ_{cal}^{unwrap}(rΔl, nT) after the phase unwrapping processing is calculated as shown in Expression (3). After that, δθ_{cal}(rΔl, nT) before the phase connection is updated to δθ_{cal}^{unwrap}(rΔl, nT) after the phase connection.

In δθ_{cal}^{unwrap}(rΔl, nT), erroneous detection of apparent large vibration due to a failure of the phase unwrapping processing caused by noise of the measuring instrument arises. However, since the magnitude of the noise randomly changes, the erroneous detection of apparent large vibration also randomly arises.

A spot where the failure of the phase unwrapping processing arises randomly arises, but a cause thereof is that large noise is generated in either θ_{cal}(rΔl, nT) or θ_{cal}((r+D)Δl, nT), which is a source of calculation of δθ_{cal}^{unwrap}(rΔl, n), in many cases. For example, it is noted that large noise generated in θ_{cal}(rΔl, nT) causes increase in probability of erroneous detection of apparent large vibration generated not only in θ_{cal}(rΔl, nT) but also in θ_{cal}((r−D)Δl, nT) at the same time.

It is also noted that fading, which affects the magnitude of noise added to θ_{cal}(rΔl, nT), causes difference in likelihood of erroneous detection of apparent large vibration for each point in the optical fiber's longitudinal distance.

### (Step S05)

An outlier is detected in the fiber's longitudinal distance direction, that is, the first-dimensional direction, with respect to δθ_{cal}^{unwrap}(rΔl, nT) that is the value after the phase connection, to estimate a phase connection error portion.

As a specific method of detecting the outlier, for example, a method using a Hampel identifier can be used. In employing the Hampel identifier, when the number of left and right sides to be referred to for determining whether the phase δθ_{cal}^{unwrap}(rΔl, nT) of rΔl in the longitudinal direction is an outlier is k, a numerical value of k can be considered in lights of the above-described D.

When k/D is considerably small, it can be considered that a fiber section [rΔl, (r+D)Δl] in which δθ_{cal}^{unwrap}(rΔl, nT) is observed and a fiber section [(r±k)Δl, (r±k+D)Δl] in which δθ_{cal}^{unwrap}((r±k)Δl, nT) is observed are approximately common. Therefore, it is considered that the phase value δθ_{cal}^{unwrap} gradually changes from (r−k)Δl to rΔl and from rΔl to (r+k)Δl, and thus it is practical to correct the failure of the phase unwrapping processing by performing outlier detection in the range of (r−k)Δl to (r+k)Δl.

As a specific condition under which k/D can be considered to be considerably small, k≤D/2 may be set. This is because the fiber section [(r±k)Δl, (r±k+D)Δl], in which δθ_{cal}^{unwrap}((r±k)Δl, nT) is observed, overlaps the fiber section [rΔl, (r+D)Δl], in which δθ_{cal}^{unwrap}(rΔl, nT) is observed by (r−k)Δl, and k≤D/2 results in a value of (r−k)Δl more than a half value of each section length DΔl, so that half or more of scatterers contributing to δθ_{cal}^{unwrap}((r±k)Δl, nT) and scatterers contributing to δθ_{cal}^{unwrap}(rΔl, nT) are common as a statistical average.

In the Hampel identifier, a standard deviation evaluated from the median and the median absolute deviation of a phase value between (r−k)Δl and (r+k)Δl, namely, a target range, is calculated, and is replaced with the median on condition that a value of δθ_{cal}^{unwrap}(rΔl, nT) increases from the median by C times the standard deviation, but as a value of C, C=3, which is a standard numerical value, may be used. However, this numerical value can be optimized to an optimum numerical value in response to a target or the like being measured.

The post-processing unit 194 updates a phase change δθ_{cal}^{unwrap}(rₕΔl, nT) at the point (at a distance rₕΔl from the injection end) recognized as the outlier to a value after the outlier correction.

### (Step S08)

It is ascertained whether n of the time nT is nₗₐₛₜ or not. Provided that n of the time nT is not nₗₐₛₜ, the processing returns to Step S03. Provided that n of the time nT is nₗₐₛₜ, the processing proceeds to Step S09.

### (Step S09)

In the signal processing system according to the present embodiment, the measurement of the backscattered light from the measurement target optical fiber 16 is ended.

It will be described below that the first problem and the second problem described above can be solved by the above-described procedure by the post-processing unit 194. First, since the present invention has a calculation algorithm capable of performing the phase connection processing and the phase connection error correction processing at intervals of sequential generation of the backscattered light data of a component I and a component Q of the backscattered light of the optical pulse signal injected at a time nT (n=1, 2, . . . ), and it is not necessary to use the measurement data after the time nT in order to process the measurement data at the time nT, it is practical to process the measurement data at the same time that the measurement data is streamed, and this is a processing flow suitable for real-time processing in principle.

In addition, in a procedure of the signal processing method according to the related art, the phase connection error correction is performed after the phase connection processing is once performed on the phase data at all the times. Therefore, in the second correction step, it is necessary to correct the phase values at all the different times at the correction target point, and the calculation amount increases. However, in the present invention, when the phase connection processing is performed from a time (n−1)T to a time nT, the phase value after completion of the phase connection error correction is used for the phase data at the time (n−1)T. Therefore, it is not necessary to perform calculation such as correcting the phase values at all the different times, and the calculation amount can be reduced.

The AD conversion function element 191 and the AD conversion function element 192 perform sampling at a speed higher than a speed constrained and determined by a spatial resolution, and thus by using outlier correction, it is practical to reduce erroneous detection of apparent large vibration caused by a failure of the phase unwrapping processing. Such a sampling conditions needs to be considered in a simple experimental system using a single frequency, but is naturally satisfied in a system where frequency multiplexing or the like is performed. Therefore, the present embodiment can be realized without changing the device configuration according to the related art.

The condition that the AD conversion function element 191 and the AD conversion function element 192 perform sampling at a speed higher than the speed constrained and determined by the spatial resolution may not be essential when, for example, a change in the vibration that is a measurement target is gentler than the spatial resolution.

When the change in the vibration that is a measurement target is gentler than the spatial resolution, the outlier correction may be performed at a data point included in a spatial range in which the vibration, being a measurement target, can be regarded as unchangingness in performing outlier detection using a Hampel identifier. Therefore, there is a possibility where a sufficient data point for performing the outlier correction is obtained even when sampling is slower than the sampling constrained and determined by the spatial resolution. That is, when the change in the vibration that is a measurement target is gentler than the spatial resolution, the first embodiment can be implemented by performing sampling at a speed higher than that of the change in the vibration that is a measurement target.

As described above, the present disclosure makes it practical to lessen a calculation amount and to thereby process measurement data in real-time at the same time that the measurement data is streamed.

### Second Embodiment

The signal processing device 19 according to the present disclosure can also be implemented on a computer and in a program, and the program can be stored on a recording medium or be provided through a network.

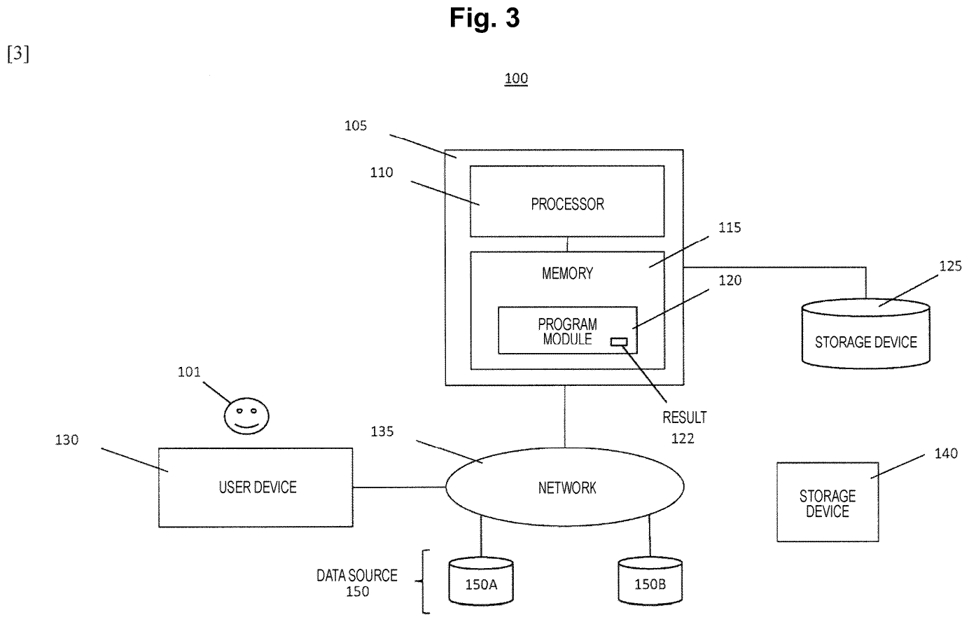

FIG. 3 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area spanning and connecting across boundaries of cities, rural areas, or countries, and (f) the Internet. Communication is performed by an electronic signal and an optical signal via the network 135.

The computer 105 includes a processor 110 and a memory 115 connected to the processor 110. In the present specification, although the computer 105 appears as a stand-alone device, the computer 105 is not limited thereto, and may be connected to other devices (not illustrated) in a distributed processing system.

The processor 110 is an electronic device including a logic circuitry that responds to and executes a command.

The memory 115 is a tangible computer-readable storage medium in which a computer program is encoded. In this regard, the memory 115 stores data and commands, i.e., program codes, which are readable and executable by the processor 110 to control the operation of the processor 110. The memory 115 can be implemented by a random access memory (RAM), a hard drive, a read-only memory (ROM), or a combination thereof. One of the components of the memory 115 is a program module 120.

The program module 120 includes commands for controlling the processor 110 to execute processes described in the present specification. In the present specification, operations are described as what is executed by the computer 105 or a method, a process, or a sub-process thereof. However, the operations are actually executed by the processor 110.

In the present specification, the term “module” is used to refer to a functional operation that can be embodied either as a stand-alone component or as an integrated configuration of a plurality of sub-components. Therefore, the program module 120 can be implemented as a single module or as a plurality of modules that operate in cooperation with each other. Furthermore, in the present specification, the program module 120 is described as what is installed in the memory 115 and thus implemented in software. However, the program module 120 can be implemented in any of hardware (e.g. electronic circuit), firmware, software, or a combination thereof.

Although the program module 120 is described as what is already loaded into the memory 115, the program module 120 may be provided on a storage device 140 so as to be subsequently loaded into the memory 115. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device located in a remote storage system (not illustrated) and connected to the computer 105 via the network 135.

The system 100 further includes a data source 150A and a data source 150B, which are collectively referred to as a data source 150 in the present specification and are communicatively connected to the network 135. In practice, the data source 150 may include any number of data sources, that is, one or more data sources. The data source 150 includes unstructured data and may include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 can provide the output to a storage device 125, such as a database or a memory, or to a remote device (not illustrated) via the network 135. For example, a program for executing operations illustrated in the flowchart of FIG. 2 may be used as the program module 120. The system 100 can be operated as the signal processing device 19.

The term “comprise(s) . . . ” or “comprising . . . ” specifies presence of a feature, an integer, a step, or a component mentioned herein, but should be understood as not excluding presence of one or more different features, integers, steps, or components, or groups thereof. The terms “a” and “an” are indefinite articles and therefore do not exclude embodiments having a plurality of features, integers, steps, or components that are the same.

### OTHER EMBODIMENTS

Note that the present invention is not limited to the above embodiments, and various modifications can be made without departing from the gist of the present invention. The present invention is not limited to the superordinate embodiments literally, and can be embodied by modifying the components without departing from the gist and the scope of the present invention at the implementation stage.

In addition, various inventions can be made by appropriately combining a plurality of components disclosed in the above embodiments. For example, some components may be deleted from all the components illustrated in the embodiments. Furthermore, components in different embodiments may be appropriately combined.

### INDUSTRIAL APPLICABILITY

The signal processing method and the signal processing device according to the present disclosure can be applied to the information communication industry.

### REFERENCE SIGNS LIST

1 Signal processing system
11 Light source
12, 141, 142, 144, 145 Coupler
13 Optical modulator
14 90-degree optical hybrid
15 Circulator
16 Measurement target optical fiber
17, 18 Balance detector
19 Signal processing device
143 Shifter
171, 181 Electrical signal
191, 192 AD conversion function element
193 Phase calculation unit
194 Post-processing unit
100 System
101 User
105 Computer
110 Processor
115 Memory
120 Program module
122 Result
125 Storage device
130 User device
135 Network
140 Storage device
150 Data source

1. A signal processing method comprising:
a calculation step of calculating a phase change at each of points on a medium from a phase of a reflected signal generated by a pulse signal transmitted to the medium, at each of predetermined times;
a phase connection step of performing phase connection processing, at each of the predetermined times, on the phase change at each of the points calculated in the calculation step; and
a correction step of detecting an outlier using a phase change at each of the points at the same time at which the phase connection processing is performed in the phase connection step, and correcting the outlier, at each of the predetermined times.

2. The signal processing method according to claim 1, wherein
in the phase connection step, for each of the points, a phase to be added to a phase change after the latest calculation step is determined depending on a magnitude of a difference between the phase change after the latest calculation step and a phase change after the correction step at a previous time.

3. The signal processing method according to claim 1, wherein
in the correction step, correction using a Hampel identifier is performed.

4. The signal processing method according to claim 1, further comprising:
before the calculation step, a reference calculation step of calculating, for each of the points, a phase difference between two points, which are the point and a point a predetermined distance away from the point, as a reference phase difference, wherein
in the calculation step, the phase difference between the two points is calculated for each of the points, and the phase change is calculated by subtracting the reference phase difference from the calculated phase difference.

5. The signal processing method according to claim 1, wherein
the medium is an optical fiber, the pulse signal is an optical pulse signal, and the reflected signal is backscattered light originating from Rayleigh scattering in the optical fiber.

6. A signal processing device comprising:
a calculation unit that calculates a phase change at each of points on a medium from a phase of a reflected signal generated by a pulse signal transmitted to the medium, at each of predetermined times;
a phase connection unit that performs phase connection processing, at each of the predetermined times, on the phase change at each of the points calculated by the calculation unit; and
a correction unit that detects an outlier using a phase change at each of the points at the same time at which the phase connection unit performs the phase connection processing, and corrects the outlier, at each of the predetermined times.

7. A non-transitory computer-readable storage medium storing a program for being implemented on a computer as the signal processing device according to claim 6.
